(19) United States
(12) Patent Application Publication
(10) Pub. No.: US 2023/0061689 A1
(43) Pub. Date: Mar. 2, 2023

(54) TRANSPORT SYSTEM, TRANSPORT CONTROL METHOD, AND STORAGE MEDIUM

(71) Applicant: TOYOTA JIDOSHA KABUSHIKI KAISHA, Toyota-shi (JP)

(72) Inventors: Kazumi SERIZAWA, Toyota-shi (JP); Hidekazu SASAKI, Yokohama-shi (JP); Daisuke SATO, Toyota-shi (JP); Shunsuke MOGI, Chofu-shi (JP)

(73) Assignee: TOYOTA JIDOSHA KABUSHIKI KAISHA, Toyota-shi (JP)

(21) Appl. No.: 17/872,176

(22) Filed: Jul. 25, 2022

(30) Foreign Application Priority Data
Aug. 31, 2021 (JP) 2021-141915

(51) Int. Cl. B60P 3/06; G05D 1/02

(52) U.S. Cl. CPC B60P 3/06; G05D 1/0274; G05D 2201/0216

(57) ABSTRACT

A transport system includes: a first moving body that is configured to transport a transport object by autonomous ground travel; a second moving body that is configured to transport the first moving body by autonomous travel; a memory; and a processor coupled to the memory and that is configured to: set delivery routes for each of the first moving body and the second moving body; stow the first moving body travelling in the first area in the second moving body at a boundary where the set delivery route switches from a first area to a second area more dirty than the first area; and cause the second moving body stowing the first moving body to travel in the second area.

### CROSS-REFERENCE TO RELATED APPLICATION

This application is based on and claims priority under 35 USC 119 from Japanese Patent Application No. 2021-141915 filed on Aug. 31, 2021, the disclosure of which is incorporated by reference herein.

### BACKGROUND

### Technical Field

The present disclosure relates to a transport system, a transport control method, and a non-transitory storage medium.

### Related Art

A delivery system for delivering packages to houses using a home delivery robot is disclosed in Japanese Patent Application Laid-Open (JP-A) No. 2020-070159. In this delivery system, after an autonomous travel vehicle that is autonomously traveling toward a parcel delivery destination has arrived in the vicinity of the parcel delivery destination, the parcel is delivered from the autonomous travel vehicle to a house by a drone or mobile robot.

However, in the delivery system described in JP-A No. 2020-070159, in cases in which the autonomous travel vehicle that has travelled through a dirty area such as outdoors then travels in an area less dirty than outdoors, such as indoors, there is a possibility of the less dirty area being dirtied.

### SUMMARY

In consideration of the above circumstances, the present disclosure provides a transport system, a transport control method, and a non-transitory storage medium storing a program that are capable of preventing a comparatively less dirty area from being dirtied.

A first aspect of the present disclosure is a transport system including a first moving body that is configured to transport a transport object by autonomous ground travel; a second moving body that is configured to transport the first moving body by autonomous travel; a memory; and a processor coupled to the memory and that is configured to: set delivery routes for each of the first moving body and the second moving body; stow the first moving body travelling in the first area in the second moving body at a boundary where the set delivery route switches from a first area to a second area more dirty than the first area; and cause the second moving body stowing the first moving body to travel in the second area.

In the transport system of the first aspect, the first moving body travelling in the first area is stowed in the second moving body at the boundary where the delivery route switches from the first area to the second area more dirty than the first area, and the second moving body stowing the first moving body is then allowed to travel in the second area. Namely, the first moving body travels in the first area and the second moving body travels in the second area more dirty than the first area, and so the second moving body travelling in the second area more dirty than the first area can be prevented from travelling in the first area less dirty than the second area, and the first moving body travelling in the first area less dirty than the second area can be prevented from travelling in the second area more dirty than the first area. This enables the first area less dirty than the second area to be prevented from being dirtied.

In the first aspect the first area may be indoors and the second area may be outdoors.

In the configuration described above the first area less dirty than the second area is indoors and the second area more dirty than the first area is outdoors. Indoors can accordingly be prevented from being dirtied.

In the first aspect wherein the second moving body may be configured to transport a plurality of the first moving body.

In the configuration described above the second moving body is capable of transporting the plural first moving bodies, enabling the plural first moving bodies to travel in the first area. Moreover, the first moving bodies are able to travel in plural first areas. This enables delivery objects to be delivered to plural delivery destinations with good efficiency.

In the first aspect, the second moving body may be equipped with a battery for supplying power to the first moving body.

In the configuration described above the second moving body is equipped with a battery capable of supplying power to the first moving body, and the first moving body is able to travel for a long distance (long time) in the first area by supplying power from the battery.

In the first aspect the second moving body may be equipped with a battery chargeable from an external power source.

In the configuration described above the second moving body is equipped with the battery chargeable from the external power source, enabling the second moving body to travel for a long distance (long time) inside the second area by charging the battery from the external power source.

In the first aspect, the processor may be further configured to set a delivery route in the first area for the first moving body, and set a delivery route in the second area for the second moving body.

In the configuration described above, the processor sets the first moving body with the delivery route in the first area, and sets the second moving body with the delivery route in the second area, thereby enabling travel areas to be split such that the first moving body travels in the first area less dirty than the second area and the second moving body travels in the second area more dirty than the first area. Due to segregating areas for travel by vehicle such that the first moving body travels in the first area and the second moving body travels in the second area, sensors, devices and the like that are appropriate to the respective travel areas can be installed to the first moving body and the second moving body. This enables the costs incurred for the first moving body and the second moving body to be reduced, and also leads to being able to expand the delivery areas.

In the first aspect, the first moving body may be equipped with a first storage section for storing a delivery route in the first area and the second moving body may be equipped with a second storage section for storing a delivery route in the second area.

In the configuration described above the first moving body is equipped with the first storage section for storing the delivery route in the first area and the second moving body is equipped with the second storage section for storing the delivery route in the second area, enabling the first moving body and the second moving body to be stored with the delivery routes respectively needed.

In the first aspect, the second storage section may be configured to store the delivery route in the first area and the delivery route in the second area; and the first storage section may be configured to receive the delivery route in the first area stored in the second storage section at a start of travel of the first moving body.

In the configuration described above the second storage section is stored with the delivery route in the first area and the delivery route in the second area, and at the start of travel the first storage section receives the delivery route in the first area stored in the second storage section. The first moving body is accordingly able to accept the delivery route needed at the time needed, and a reduction can be achieved in the volume of data stored at any one time in the first storage section.

In the first aspect, the first moving body may receive map information about a facility containing the first area from the facility, and may return or erase the map information when the first moving body exits from the facility.

In the configuration described above the first moving body accepts the map information about the facility containing the first area from the facility, and returns or erases the map information when exiting from the facility. This enables the security of the facility containing the first area to be raised.

In the first aspect the map information may be shared in cloud.

In the configuration described above the map information is shared in cloud, thereby enabling the same map information to be shared between plural of the first moving bodies.

A second aspect of the present disclosure is transport control method including: setting delivery routes for each of a first moving body that is configured to transport a transport object by autonomous ground travel and a second moving body that is configured to transport the first moving body by autonomous travel; stowing the first moving body autonomously travelling in the first area in the second moving body at a boundary where the set delivery route switches from a first area to a second area more dirty than the first area; and causing the second moving body stowing the first moving body to travel autonomously in the second area.

A third aspect of the present disclosure is a non-transitory storage medium storing a program executable by a computer to perform transport control processing, the transport control processing including: setting delivery routes for each of a first moving body that is configured to transport a transport object by autonomous ground travel and a second moving body that is configured to transport the first moving body by autonomous travel; stowing the first moving body autonomously travelling in the first area in the second moving body at a boundary where the set delivery route switches from a first area to a second area more dirty than the first area; and causing the second moving body stowing the first moving body to travel autonomously in the second area.

The transport system, transport control method, and non-transitory storage medium storing a program according to the present disclosure enable a comparatively less dirty area to be prevented from being dirtied due to enabling the movement ranges of a first moving body and a second moving body to be limited to the comparatively less dirty area (first) and an area other than the comparatively less dirty area (second), respectively.

### BRIEF DESCRIPTION OF THE DRAWINGS

FIG. 1 is a schematic diagram illustrating a schematic configuration of a transport system according to an exemplary embodiment.

FIG. 2 is a side view schematically illustrating a configuration of a delivery vehicle configuring part of the transport system according to the present exemplary embodiment.

FIG. 3 is a block diagram illustrating a hardware configuration of a delivery vehicle configuring part of the transport system according to the present exemplary embodiment.

FIG. 4 is a block diagram illustrating a functional configuration of a control device installed in a delivery vehicle configuring part of the transport system according to the present exemplary embodiment.

FIG. 5 is a side view schematically illustrating a configuration of a large delivery vehicle configuring part of the transport system according to the present exemplary embodiment.

FIG. 6 is a block diagram illustrating a hardware configuration of a large delivery vehicle configuring part of the transport system according to the present exemplary embodiment.

FIG. 7 is a block diagram illustrating a functional configuration of a control device installed in a large delivery vehicle configuring part of the transport system according to the present exemplary embodiment.

FIG. 8 is a block diagram illustrating a hardware configuration of a server configuring part of the transport system according to the present exemplary embodiment.

FIG. 9 is a block diagram illustrating a functional configuration of a server configuring part of the transport system according to the present exemplary embodiment.

FIG. 10A is a flowchart (first flowchart) illustrating an example of a flow of a chain of processing in a transport system according to an exemplary embodiment.

FIG. 10B is a flowchart (second flowchart) illustrating an example of a flow of a chain of processing in a transport system according to an exemplary embodiment.

### DETAILED DESCRIPTION

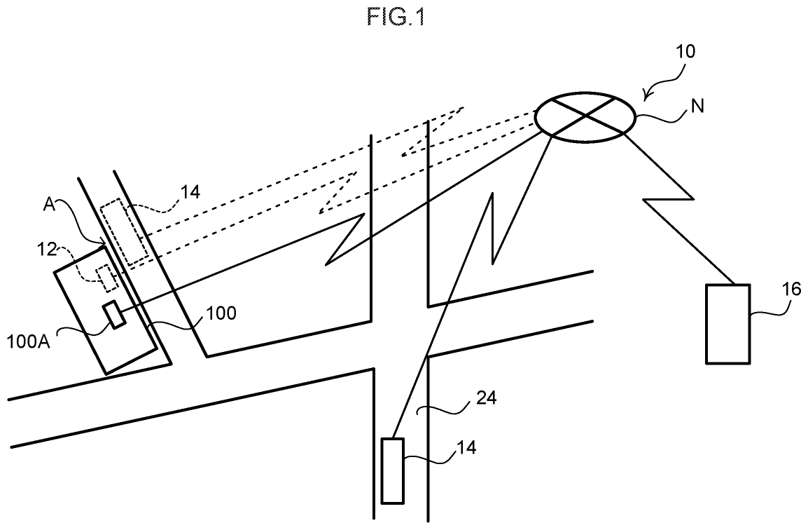

Explanation follows regarding a transport system 10 according to an exemplary embodiment of the present disclosure, with reference to FIG. 1 to FIG. 10B. As illustrated in FIG. 1, the transport system 10 includes a delivery vehicle 12 serving as a first moving body, a large delivery vehicle 14 serving as a second moving body, and a server 16. The delivery vehicle 12 of the present exemplary embodiment is a vehicle for traveling indoors, and travels in the interior of a facility 100 such as, for example, a factory, an apartment block, or a multi-tenancy building.

A later described control section 36 of the delivery vehicle 12, a later described control section 80 of the large delivery vehicle 14, a management system 100A of the facility 100, and the server 16 are configured so as to be capable of communicating with each other over a network N.

Delivery Vehicle 12

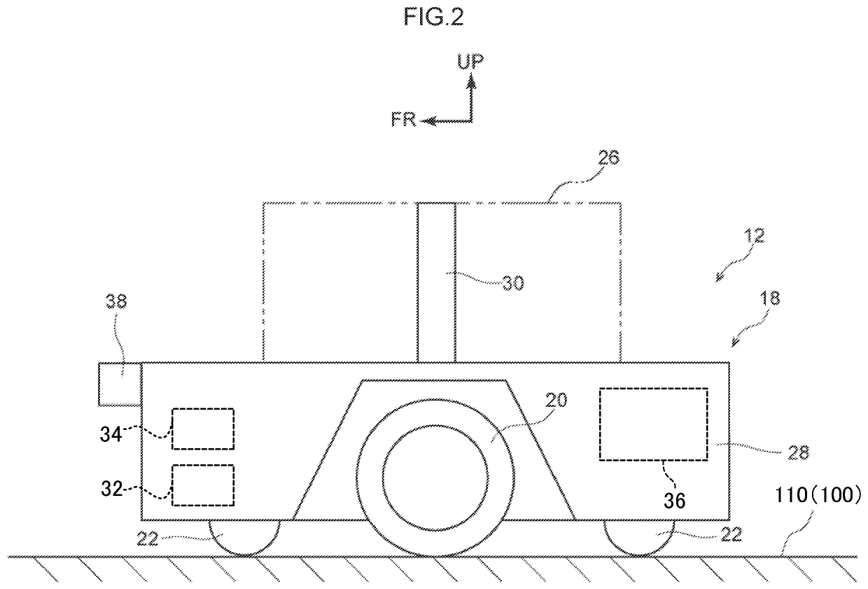

As illustrated in FIG. 2, the delivery vehicle 12 is equipped with a main body 18, a pair of driven wheels 20, and a pair of casters 22. The delivery vehicle 12 is capable of traveling on an indoor floor surface (first area) 110 of the facility 100 and transporting a transport object 26. Examples of the transport object 26 include various goods that have been packaged in corrugated cardboard boxes.

The arrow FR in FIG. 2 indicates forward in a front-rear direction of the delivery vehicle 12, and the arrow UP indicates upward in the height direction of the delivery vehicle 12. Moreover, unless particularly indicated otherwise, in the following explanation of the delivery vehicle 12 reference to the front-rear direction means the front-rear direction of the delivery vehicle 12, reference to the height direction means the height direction of the delivery vehicle 12, and reference to a width direction means the width direction of the delivery vehicle 12.

The main body 18 is equipped with a vehicle body 28, and a holding device 30. The vehicle body 28 has a cuboidal shape with a length direction aligned with the front-rear direction, and the transport object 26 is able to be mounted on a top surface of the vehicle body 28. The holding device 30 is provided to a portion on the upper side of the vehicle body 28 in the height direction, and is capable of gripping the transport object 26 that has been mounted on the vehicle body 28 by gripping in the width direction.

The driven wheels 20 are provided at the two width direction sides of a front-rear direction central portion of the vehicle body 28. A motor 32 for applying drive force to the driven wheels 20 is coupled to each of the driven wheels 20 through a non-illustrated drive shaft. The casters 22 are provided at a width direction central portion of portions at the respective front-rear direction two ends of the vehicle body 28.

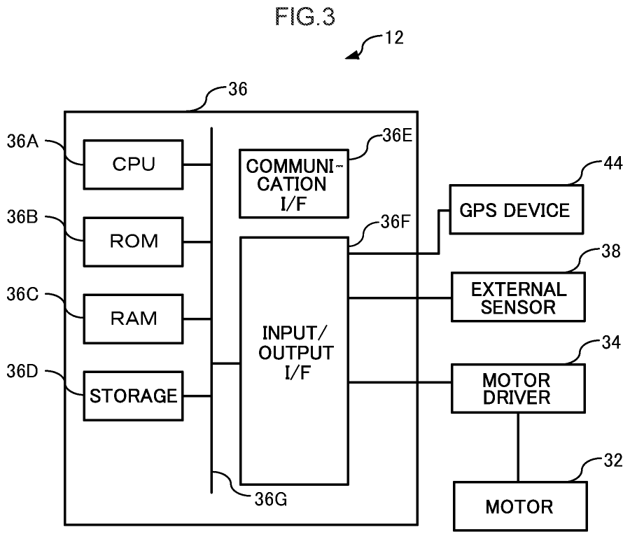

A pair of motor drivers 34 and control sections 36 are installed to the vehicle body 28. The motor drivers 34 are each electrically connected to the corresponding motor 32 and control section 36 (see FIG. 3). A configuration is adopted in which electrical power is supplied to electrical devices, such as the motors 32, installed to the delivery vehicle 12 from a non-illustrated battery also installed to the vehicle body 28. The driven wheels 20 are driven by power supplied to the motors 32. Namely, the delivery vehicle 12 of the present exemplary embodiment is a type of battery electric vehicle (BEV). Note that in the present exemplary embodiment, for example, this battery may be electrically supplied from a later described battery 54 installed to the large delivery vehicle 14.

External sensors 38 are provided on a front face of the vehicle body 28, and a global positioning system (GPS) device 44 (see FIG. 3) is also installed to the vehicle body 28 as a position acquisition section.

In the present exemplary embodiment the control section 36 controls travel of the delivery vehicle 12 based on data acquired with the external sensors 38 and the GPS device 44, and based on a delivery route stored in storage 36D, described later.

As illustrated in FIG. 3, the control section 36 includes a central processing unit (CPU) 36A serving as an example of a processor, read only memory (ROM) 36B, random access memory (RAM) 36C, the storage 36D, a communication interface (I/F) 36E, and an input/output I/F 36F. The CPU 36A, the ROM 36B, the RAM 36C, the storage 36D, the communication I/F 36E, and the input/output I/F 36F are connected together so as to be capable of communicating with each other through a bus 36G.

The CPU 36A is a central processing unit capable of executing various programs according to various controls of the delivery vehicle 12. Specifically, the CPU 36A reads a program from the ROM 36B, and is able to execute the program using the RAM 36C as workspace. An execution program stored in the ROM 36B is read and executed by the CPU 36A, so as to enable the control section 36 to exhibit various functions, as described later.

The storage 36D includes a hard disk drive (HDD) or a solid state drive (SSD), and is stored with various programs including an operating system and various data including map data. The storage 36D also functions as a first storage section, and is stored with a delivery route inside the facility 100 as set by a route setting section 98, described later, and with map information of the facility 100 accepted over the network N from the management system 100A of the facility 100.

The communication I/F 36E serves as an interface employed to connect the control section 36 and the network N together, and the large delivery vehicle 14 and the server 16, and the management system 100A etc. of the facility 100 are able to communicate over the network N. A communication standard such as, for example, Ethernet®, FDDI, WiFi® or the like, is employed for this interface.

The input/output I/F 36F serves as an interface for the control section 36 to communicate with various devices installed to the delivery vehicle 12. The control section 36 is connected through the input/output I/F 36F to each of the devices, described later, so as to enable mutual communication therebetween. Note that these devices may be directly connected to the bus 36G.

More specifically, the motor drivers 34, the external sensors 38, and the GPS device 44 are connected to the input/output I/F 36F.

The motor drivers 34 output control signals to the motors 32 based on command signals input from the control section 36, so as to enable the rotation speed, rotation direction, and the like of the motors 32 to be controlled. In the present exemplary embodiment, the direction of progression of the delivery vehicle 12 is changeable by independently controlling the respective rotation speed, rotation direction, and the like of the pair of motors 32 using the control section 36 and the pair of motor drivers 34.

The external sensors 38 serve as a sensor group for detecting the surrounding environment of the delivery vehicle 12 at specific time intervals. The external sensors 38 include at least one out of a camera capable of imaging the surroundings of the delivery vehicle 12, a millimeter-wave radar for transmitting probe waves in a specific range, or a laser imaging detection and ranging (LIDAR) for scanning a specific range. The results of detecting objects etc. in the surroundings of the delivery vehicle 12 as acquired by the external sensors 38 are temporarily stored in the storage 36D.

The GPS device 44 includes a non-illustrated antenna for receiving signals from non-illustrated artificial satellites (GPS satellites), and is able to measure the current position of the delivery vehicle 12. The position information of the delivery vehicle 12 as measured by the GPS device 44 is temporarily stored in the storage 36D, and is configured so as to be updated at specific time intervals.

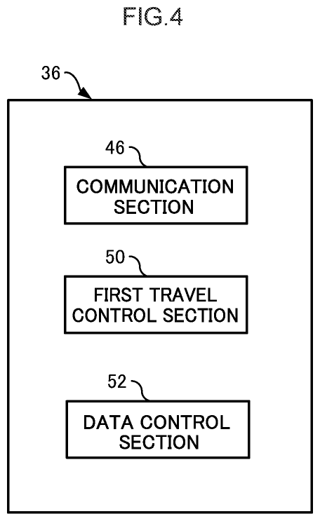

Next, explanation follows regarding a functional configuration of the control section 36, with reference to FIG. 4. In the control section 36, the CPU 36A reads an execution program stored in the ROM 36B, and by executing this program functions as a communication section 46 and a first travel control section 50.

The communication section 46 is able to communicate with the large delivery vehicle 14 and the server 16, and the management system 100A etc. of the facility 100 over the network N.

The first travel control section 50 inputs control signals to the motor drivers 34 based on a delivery route inside the facility 100 stored in the storage 36D, on map information of the facility 100 accepted over the network N from the facility 100, and on the surrounding environment of the delivery vehicle 12 as acquired by the external sensors 38, so as to control the motor drivers 34 and the like such that the delivery vehicle 12 travels toward a destination. The first travel control section 50 is also able to control the motors 32 through the motor drivers 34 when an object has been detected in the vicinity of the delivery vehicle 12 by the external sensors 38, enabling the delivery vehicle 12 to be temporarily halted.

The first travel control section 50 also halts the delivery vehicle 12 at a boundary A (see FIG. 1) where there is a switch from inside the facility 100 to outside the facility 100. Namely, the first travel control section 50 controls the motors 32 through the motor drivers 34 such that the delivery vehicle 12 does not move outside the facility 100 at the boundary A. The first travel control section 50 is also configured so as to transmit position information of the delivery vehicle 12 to the large delivery vehicle 14 through a communication section 48.

Specifically, the first travel control section 50 is configured so as to detect the delivery vehicle 12 breaking out of the facility 100 (or entrance into an exterior to the facility 100) based on the position information of the delivery vehicle 12 as measured by the GPS device 44 and on a surrounding situation of the delivery vehicle 12 as detected by the external sensors 38. Reference here to “detecting . . . breaking out” means detecting that at least a portion of the vehicle body 28 has broken out from the facility 100, and means a state prior to one or more of the driven wheels 20 or the casters 22 traveling outside the facility 100.

A configuration is adopted such that when the delivery vehicle 12 is detected as breaking out from the facility 100 by the first travel control section 50, and the first travel control section 50 halts the delivery vehicle 12 and transmits the position information of the delivery vehicle 12 to the large delivery vehicle 14 and the server 16 through the communication section 48.

A data control section 52 acquires map information for inside the facility 100, which includes area information such as information related to facilities such as elevators in the interior of the facility 100, maintenance facility information, and the like, by acquisition from the management system 100A of the facility 100. As an example, in the present exemplary embodiment the data control section 52 is configured so as to acquire only information required for a delivery route from out of the map information for inside the facility 100. Map information and the like for inside the facility 100 other than the delivery route is accordingly not acquired.

The data control section 52 erases the map information for inside the facility 100 after delivery or after pickup of the transport object 26. Namely, after arriving at the destination and completion of delivery or pickup of the transport object 26, the delivery vehicle 12 returns to the entrance to the facility 100 (the boundary A), and afterwards the map information for inside the facility 100 that is stored in the delivery vehicle 12 is erased by the data control section 52.

Note that a configuration may be adopted in which the map information for inside the facility 100 is erased from the delivery vehicle 12 by transmitting the map information for inside the facility 100 to the management system 100A, and the delivery vehicle 12 is permitted to exit from the facility 100 after confirmation that the data has been erased by the management system 100A.

Large Delivery Vehicle 14

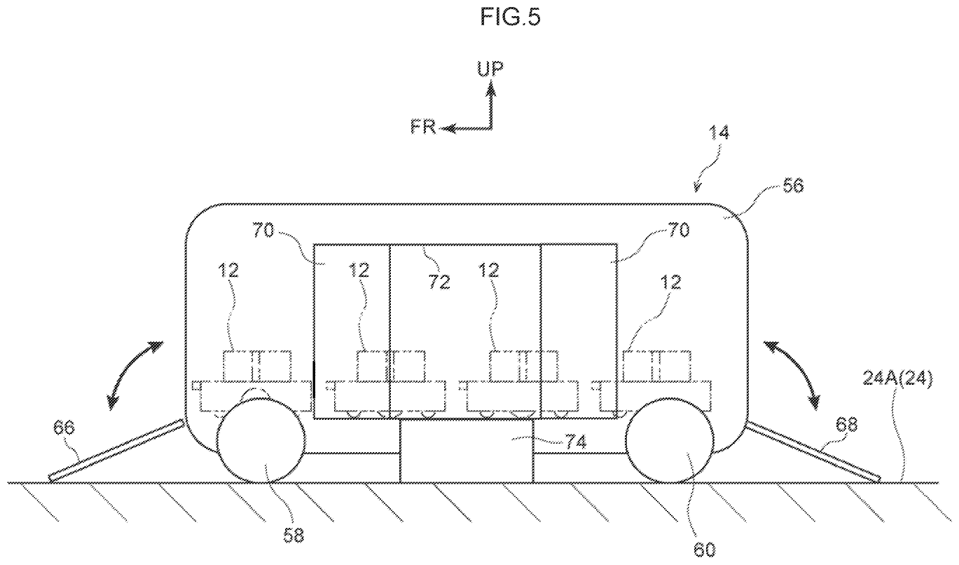

Next, description follows regarding a configuration of the large delivery vehicle 14, with reference to FIG. 5. As illustrated in FIG. 5, the large delivery vehicle 14 is equipped with a vehicle body 56, a pair of steered wheels 58, and a pair of driven wheels 60, and is capable of traveling on a road surface (second area) 24A of a road 24 and transporting the delivery vehicle 12.

The arrow FR in FIG. 5 indicates forward in a front-rear direction of the large delivery vehicle 14, and the arrow UP indicates upward in the height direction of the large delivery vehicle 14. Moreover, unless particularly indicated otherwise, in the following explanation of the large delivery vehicle 14 reference to the front-rear direction means the front-rear direction of the large delivery vehicle 14, reference to the height direction means the height direction of the large delivery vehicle 14, and reference to a width direction means the width direction of the large delivery vehicle 14.

The vehicle body 56 has a cuboidal shape with a length direction aligned with the front-rear direction, and plural of the delivery vehicles 12 are able to be stowed inside the vehicle body 56.

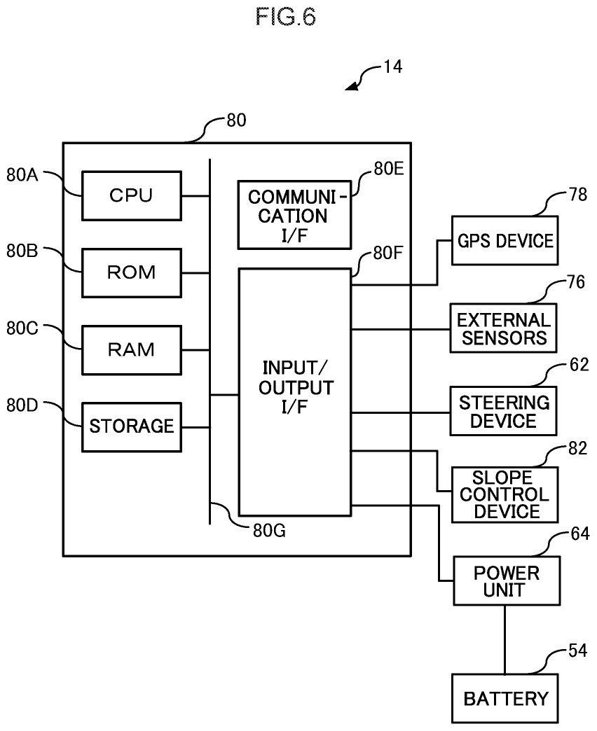

The steered wheels 58 are provided at the two width direction sides of a front-rear direction front side portion of the vehicle body 56. These steered wheels 58 are configured so as to be driven by a steering device 62 (see FIG. 6) installed to the vehicle body 56.

The driven wheels 60 are provided at the two width direction sides of a front-rear direction rear side portion of the vehicle body 56. These driven wheels 60 are configured so as to be driven by a power unit 64 (see FIG. 6) installed to the vehicle body 56.

A front slope board 66 is provided to the front-rear direction front face of the vehicle body 56. The front slope board 66 is provided so as to be swingable with respect to the vehicle body 56, and at normal times configures a portion of the front face of the vehicle body 56. However, in a deployed state the front slope board 66 is disposed with a downward gradient from the vehicle body 56, with the delivery vehicle 12 able to travel on the top face of the front slope board 66.

A rear slope board 68 is provided to the front-rear direction rear face of the vehicle body 56. The rear slope board 68 is provided so as to be swingable with respect to the vehicle body 56, and at normal times configures a portion of the rear face of the vehicle body 56. However, in a deployed state the rear slope board 68 is disposed with a downward gradient from the vehicle body 56, with the delivery vehicle 12 able to travel on the top face of the rear slope board 68.

Furthermore, an opening 72 with a pair of openable sliding doors 70 is provided to a side face of the vehicle body 56, and a side slope board 74 is provided at a portion below the opening 72 in the height direction. The side slope board 74 is stored in the vehicle body 56 at normal times, however, when in a deployed state the side slope board 74 extends toward the width direction outside and downward in the height direction. In a deployed state of the side slope board 74 the delivery vehicle 12 is able to travel on the top face of the side slope board 74.

As illustrated in FIG. 6, external sensors 76 configured similarly to the external sensors 38, and a GPS device 78 configured similarly to the GPS device 44, are installed to the vehicle body 56.

In the present exemplary embodiment, a control section 80 installed to the vehicle body 56 is configured so as to control travel of the large delivery vehicle 14 based on data acquired by the external sensors 76 and the GPS device 78, on delivery routes and map information stored in storage 80D, described later, and on signals received from the delivery vehicle 12.

The control section 80 is configured similarly to the control section 36 and includes a CPU 80A serving as an example of a processor, ROM 80B, RAM 80C, storage 80D, communication I/F 80E, input/output I/F 80F, and bus 80G.

The steering device 62, the power unit 64, the external sensors 76, the GPS device 78, and a slope control device 82 are connected to the input/output I/F 80F. Note that these devices may be directly connected to the bus 80G.

The steering device 62 includes a non-illustrated actuator capable of changing steering angle of the steered wheels 58, and a non-illustrated control section for controlling the actuator, such that the steering angle of the steered wheels 58 is controlled based on a command signal input to this control section from the control section 80.

The power unit 64 includes a non-illustrated drive section such as an engine or motor, and a non-illustrated control section for controlling the drive section, in a configuration such that the output of the drive section is controlled based on a command signal input to this control section from the control section 80. In the present exemplary embodiment, as an example the drive section is configured by a motor, such that electrical power from a battery 54 (see FIG. 6) installed to the vehicle body 56 is supplied to the power unit 64. Namely the driven wheels 60 are driven by supply of electrical power to the motor. The large delivery vehicle 14 of the present exemplary embodiment is accordingly a type of BEV. Note that the battery 54 is, for example, chargeable from the facility 100 or from an external power source, such a public facility.

The slope control device 82 includes a non-illustrated actuator to drive the front slope board 66, a non-illustrated actuator to drive the rear slope board 68, a non-illustrated actuator to drive the sliding doors 70, a non-illustrated actuator to drive the side slope board 74, and a non-illustrated control section to control these actuators.

The slope control device 82 is configured so as to drive the front slope board 66, the rear slope board 68, the sliding doors 70, and the side slope board 74 based on command signals input to this control section from the control section 80.

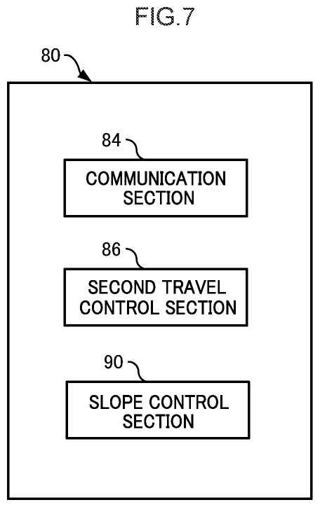

Next, description follows regarding a functional configuration of the control section 80, with reference to FIG. 7. In the control section 80 the CPU 80A reads an execution program stored in the ROM 80B and by executing this program functions as a collective body of a communication section 84, a second travel control section 86, and a slope control section 90.

The communication section 84 is capable of communicating with the delivery vehicle 12, the server 16, and the management system 100A etc. of the facility 100 over the network N.

The second travel control section 86 inputs a control signal to the steering device 62 and the power unit 64 based on the delivery route outside the facility 100 stored in the storage 80D, on the map information accepted over the network N, on the position information of the delivery vehicle 12 received from the delivery vehicle 12 through the communication section 84, on the position information of the large delivery vehicle 14 acquired by the GPS device 78, and on the surrounding environment of the large delivery vehicle 14 acquired by the external sensors 76. The second travel control section 86 controls the steering device 62, the power unit 64, and the like such that the large delivery vehicle 14 travels toward a destination. The second travel control section 86 also controls the steering device 62 and the power unit 64 when an object has been detected in the vicinity of the large delivery vehicle 14 using the external sensors 76, such that the large delivery vehicle 14 is able to be temporarily halted.

The second travel control section 86 also stows the delivery vehicle 12 in the large delivery vehicle 14 at the boundary A where there is a switch from inside the facility 100 to outside the facility 100 (see FIG. 1), and then allows the large delivery vehicle 14 stowing the delivery vehicle 12 to travel on the road surface 24A of the road 24 outside the facility 100. Namely, the first travel control section 50 causes the large delivery vehicle 14 to travel as far as the boundary A where the delivery vehicle 12 is temporarily halted based on the position information of the delivery vehicle 12 received through the communication section 84 and on the position information of the large delivery vehicle 14 acquired by the GPS device 78, and at the boundary A stows the delivery vehicle 12 that has halted after traveling inside the facility 100. The large delivery vehicle 14 then travels on the road surface 24A of the road 24 based on the delivery route outside the facility 100 stored in the storage 80D.

The second travel control section 86 halts the large delivery vehicle 14 when the large delivery vehicle 14 has arrived at the boundary A, and is configured to transmit an arrival signal to the slope control section 90.

Note that in the present exemplary embodiment the first travel control section 50 of the delivery vehicle 12, and the second travel control section 86 of the large delivery vehicle 14, configure a travel control section of the present disclosure.

On receipt of the arrival signal from the second travel control section 86, the slope control section 90 controls the slope control device 82, deploys at least one out of the front slope board 66, the rear slope board 68, or the side slope board 74, and transmits a stowing signal to the delivery vehicle 12 through the communication section 84.

The first travel control section 50 of the delivery vehicle 12 that has received the stowing signal controls the motor drivers 34 based on the surrounding environment of the delivery vehicle 12 acquired by the external sensors 38, so as to cause the delivery vehicle 12 to enter inside the vehicle body 56 of the large delivery vehicle 14.

Server 16

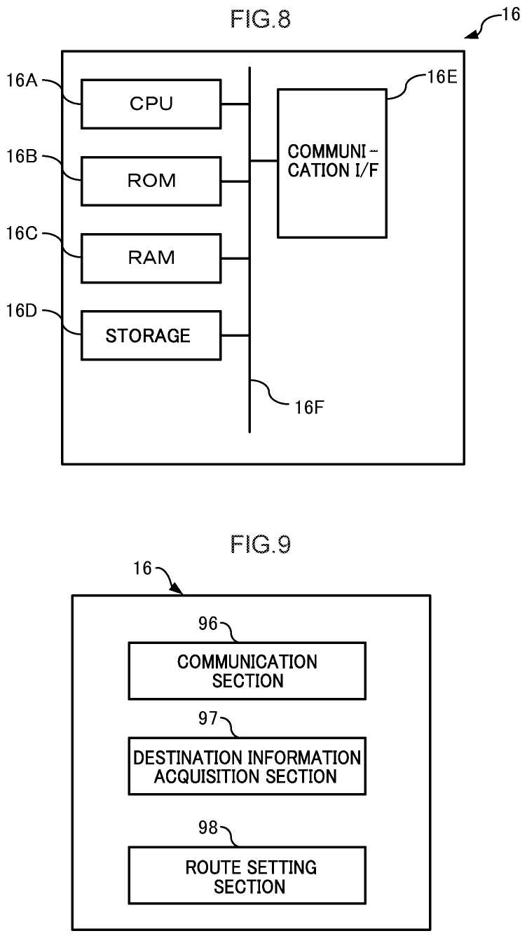

Next, description follows regarding a configuration of the server 16, with reference to FIG. 8. The server 16 includes a CPU 16A, ROM 16B, RAM 16C, storage 16D, and a communication I/F 16E. The CPU 16A, the ROM 16B, the RAM 16C, the storage 16D, and the communication I/F 16E are connected together through a bus 16F so as be able to communicate with each other. Note that the CPU 16A, the ROM 16B, the RAM 16C, the storage 16D, and the communication I/F 16E are equipped with basically similar functions to the configuration of the control section 36 described above.

Various types of information needed for the delivery vehicle 12 and the large delivery vehicle 14 to deliver or pick up the transport object 26 are stored in the storage 16D. For example, information stored in the server 16 includes information about a delivery requester, information related to a delivery destination, information related to a delivery route to the delivery destination, and the like.

In cases in which information such as the address of the destination is stored in the server 16, a destination information acquisition section 97, described later, may access the server 16 periodically and acquire information such as destination addresses.

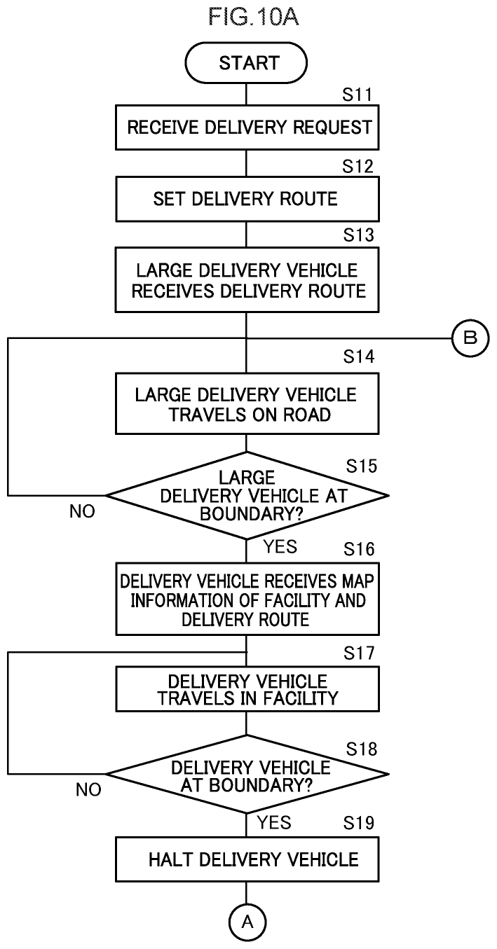

Then by an execution program stored in the ROM 16B being read and executed by the CPU 16A, the server 16 functions as a communication section 96, a destination information acquisition section 97, and a route setting section 98, as illustrated in FIG. 9.

The communication section 96 is able to exchange various information with the delivery vehicle 12, the large delivery vehicle 14, and the management system 100A of the facility 100 over the network N.

The destination information acquisition section 97 acquires information such as destination addresses. Specifically, on receipt by a management company or the like of the transport system 10 of a request for a delivery or a pickup of a transport object 26, a delivery or a pickup instruction is transmitted from the management company to the transport system 10. When this is performed information such as the address of the delivery destination or pickup destination is transmitted from the management company system to the transport system 10. The destination information acquisition section 97 acquires by receiving the information such as the address of the delivery destination or pickup destination from the management company over the network N.

The route setting section 98 sets the respective delivery routes of the delivery vehicle 12 and the large delivery vehicle 14. Specifically, a delivery route inside the facility 100 is set for the delivery vehicle 12, and a delivery route outside the facility 100 is set for the large delivery vehicle 14, based on the information such as the address of the delivery or pickup acquired by the destination information acquisition section 97. Note that in cases in which the delivery destinations include not only the facility 100 but plural facilities, a delivery route is set for each of the delivery vehicles 12 inside at least one facility, and a delivery route is set for the large delivery vehicle 14 outside the plural facilities, i.e. on the road 24 or the like.

As an example of the present exemplary embodiment, each of the delivery routes of the delivery vehicle 12 and the large delivery vehicle 14 set by the route setting section 98 is stored over the network N in the storage 80D of the large delivery vehicle 14. At the start of travel, the delivery vehicle 12 receives over the network N the delivery route for the delivery vehicle 12 stored in the storage 80D, and stores the delivery route in the storage 36D.

### Operation and Advantageous Effects of Present Exemplary Embodiment

Next, description follows regarding the operation and advantageous effects of the present exemplary embodiment.

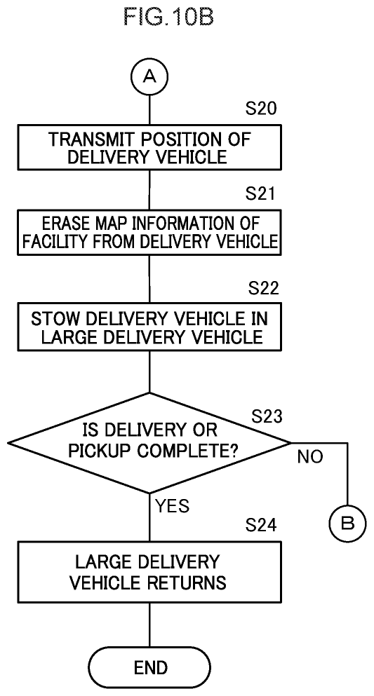

Explanation follow regarding a flow of a chain of processing in the transport system 10, mainly referring to the flowcharts illustrated in FIG. 10A and FIG. 10B. As illustrated in FIG. 10A, in the transport system 10 according to the present exemplary embodiment, first at step S11, a request for a delivery or pickup of a transport object 26 is received from the management company or the like of the transport system 10, and information such as the address of the delivery destination or pickup destination is received by the destination information acquisition section 97 of the server 16.

At step S12, based on the information such as the received delivery or pickup address, the route setting section 98 of the server 16 sets a delivery route inside the facility 100 as an example of the delivery destination or pickup destination for the delivery vehicle 12, and sets a delivery route outside the facility 100 for the large delivery vehicle 14.

At step S13, the large delivery vehicle 14 receives the delivery route set by the route setting section 98, and stores the delivery route in the storage 80D. Note that map information and the like receiver over the network N is also stored in the storage 80D.

At step S14, the large delivery vehicle 14 travels on the road surface 24A of the road 24 (see FIG. 1) toward the facility 100.

At step S15, the second travel control section 86 of the large delivery vehicle 14 determines whether or not the large delivery vehicle 14 has arrived at the boundary A where there is a switch from inside the facility 100 to outside the facility 100 (see FIG. 1). Processing transitions to step S14 in cases in which there is no arrival yet (step S15: NO), and the large delivery vehicle 14 continues to travel on the road surface 24A of the road 24 until arriving at the boundary A.

However, processing transitions to step S16 in cases in which at step S15 the large delivery vehicle 14 has been arrived at the boundary A (step S15: YES), the delivery vehicle 12 stowed in the large delivery vehicle 14 receives map information of the facility 100 from the facility 100 over the network N, and receives the delivery route inside the facility 100 set for the delivery vehicle 12 from out of the delivery routes stored in the storage 80D of the large delivery vehicle 14. Note that the received map information and delivery route are stored in the storage 36D of the delivery vehicle 12.

At step S17, after exiting from the large delivery vehicle 14 the delivery vehicle 12 travels on a floor surface 110 inside the facility 100 based on the map information and delivery route stored in the storage 36D.

At step S18, the first travel control section 50 of the delivery vehicle 12 determines whether or not the boundary A where there is a switch from inside the facility 100 to outside the facility 100 (see FIG. 1) has been arrived at. In cases in which the delivery vehicle 12 has not yet arrived at the boundary A (step S18: NO), this is interpreted as the delivery or pickup of the transport object 26 not yet being completed, and so processing transitions to step S17, and the delivery vehicle 12 continues to travel inside the facility 100 until arriving at the boundary A.

In cases in which at step S18 the delivery vehicle 12 has been arrived at the boundary A (step S18: YES), processing transitions to step S19, and the delivery vehicle 12 that travelled inside the facility 100 is halted by the first travel control section 50.

Next, as illustrated in FIG. 10B, at step S20, the first travel control section 50 of the delivery vehicle 12 transmits the position information of the delivery vehicle 12 to the large delivery vehicle 14 and the server 16 through the communication section 48.

At step S21, after the delivery or pickup of the transport object 26 has been completed and the delivery vehicle 12 has returned to the entrance to the facility 100 (the boundary A), the data control section 52 of the delivery vehicle 12 erases the map information for inside the facility 100 stored in the delivery vehicle 12.

At step S22, the large delivery vehicle 14 stows the delivery vehicle 12. In cases in which the large delivery vehicle 14 is not at the boundary A at this time, based on the position information of the delivery vehicle 12 received through the communication section 84 and on the position information of the large delivery vehicle 14 acquired by the GPS device 78, the second travel control section 86 causes the large delivery vehicle 14 to travel as far as the boundary A where the delivery vehicle 12 has halted, and stows the delivery vehicle 12 that has halted at the boundary A after traveling inside the facility 100 inside the large delivery vehicle 14.

Then at step S23, the control section 80 of the large delivery vehicle 14 determines whether or not the delivery or pickup of the transport object 26 has been completed. Specifically, the control section 80 determines whether or not the travel along the delivery route stored in the storage 80D has ended. In cases in which the delivery or pickup of the transport object 26 is not yet complete (step S23: NO), processing transitions to step S14 of FIG. 10A, and the second travel control section 86 allows the large delivery vehicle 14 to travel on the road 24 based on the delivery route. Note that in cases in which all deliveries or pickups of the transport objects 26 inside the facility 100 are not yet complete, the delivery vehicle 12 may travel several times inside the facility 100 by the delivery vehicle 12 being supplied with power from the battery 54 of the large delivery vehicle 14.

At step S23, in cases in which the deliveries or pickups of the transport objects 26 has been completed (step S23: YES) processing transitions to step S24, the second travel control section 86 allows the large delivery vehicle 14 to travel on the road 24 based on the delivery route, the large delivery vehicle 14 returns to an original standby location such as a garage, and the processing is ended.

In this manner, in the transport system 10 of the present exemplary embodiment, the delivery vehicle 12 that travels inside the facility 100 is stowed in the large delivery vehicle 14 at the boundary A where the delivery route switches from inside the facility 100 to outside the facility 100, and the large delivery vehicle 14 stowing the delivery vehicle 12 is then allowed to travel on the road 24 outside the facility 100. Namely, the delivery vehicle 12 travels inside the facility 100, and the large delivery vehicle 14 travels outside the facility 100, i.e. on the road 24, where it is more dirty than inside the facility 100. This means that the large delivery vehicle 14 that travels on the road 24 more dirty than inside the facility 100 can be prevented from traveling inside the facility 100 less dirty than the road 24, and the delivery vehicle 12 that travels inside the facility 100 less dirty than the road 24 can be prevented from traveling on the road 24 more dirty than inside the facility 100. This enables the inside of the facility 100 that is less dirty than the road 24 to be prevented from being dirtied. Moreover, the driven wheels 20 and the casters 22 of the delivery vehicle 12 can be prevented from being dirtied.

Moreover, in the transport system 10 according to the present exemplary embodiment, the large delivery vehicle 14 is able to transport plural of the delivery vehicles 12, and so this enables plural of the delivery vehicle 12 to travel inside the facility 100. The delivery vehicles 12 are also able to travel inside plural facilities. This enables delivery objects to be delivered with good efficiency to plural delivery destinations.

Moreover, in the transport system 10 of the present exemplary embodiment, the large delivery vehicle 14 is equipped with the battery 54 capable of supplying power to the delivery vehicle 12, enabling the delivery vehicle 12 to travel for a long distance (long time) inside the facility 100 by supplying power from the battery 54.

In the transport system 10 of the present exemplary embodiment the large delivery vehicle 14 is equipped with the battery 54 capable of being charged from an external power source, and so the large delivery vehicle 14 is able to travel a long distance (or long time) outside the facility 100, i.e. on the road 24, by charging the battery 54 from an external power source.

In the transport system 10 of the present exemplary embodiment, the route setting section 98 also sets the delivery route inside the facility 100 for the delivery vehicle 12, and sets the delivery route outside the facility 100, i.e. on the road 24, for the large delivery vehicle 14. This enables travel areas to be separated such that the delivery vehicle 12 travels inside the facility 100 that is less dirty than the road 24, and the large delivery vehicle 14 travels on the road 24 that is more dirty than inside the facility 100.

Due to the delivery vehicle 12 traveling inside the facility 100 and the large delivery vehicle 14 traveling outside the facility 100, i.e. on the road 24, in this manner, sensors and devices etc. that are appropriate to the respective travel areas can be installed due to the areas to be travelled being segregated by vehicle. This enables the costs incurred for the delivery vehicle 12 and the large delivery vehicle 14 to be reduced, and also leads to being able to expand the delivery areas.

In the transport system 10 of the present exemplary embodiment the delivery vehicle 12 is equipped with the storage 36D serving as the first storage section for storing the delivery route inside the facility 100, and the large delivery vehicle 14 is equipped with the storage 80D serving as the second storage section for storing the delivery route outside the facility 100, i.e. on the road 24. This enables the delivery vehicle 12 and the large delivery vehicle 14 to store the respective delivery routes that they need.

Moreover, in the transport system 10 of the present exemplary embodiment, the storage 80D is stored with the delivery route inside the facility 100 and the delivery route outside the facility 100, i.e. on the road 24, and at the start of travel the storage 36D receives the delivery route inside the facility 100 that is stored in the storage 80D. The delivery vehicle 12 is thereby able to accept the delivery route needed at the time it is needed, and a reduction can be achieved in the volume of data stored at any one time in the storage 36D of the delivery vehicle 12.

In the transport system 10 of the present exemplary embodiment the delivery vehicle 12 accepts the map information of the facility 100 from the facility 100, and returns or erases the map information when exiting from the facility 100. This enables the security of the facility 100 to be raised.

Although explanation has been given above regarding the transport system 10 according to an exemplary embodiment, the present disclosure is not limited thereto. Although in the exemplary embodiment described above the data control section 52 is configured so as to acquire only the information needed for the delivery route from out of the map information for inside the facility 100, there is no limitation thereto. For example, the data control section 52 may acquire all of the map information for inside the facility 100.

Moreover, although in the exemplary embodiment described above the data control section 52 acquires the map information for inside the facility 100, the present disclosure is not limited thereto. For example, the map information for inside the facility 100 may be shared in cloud. Adopting this approach would enable the same map information for inside the facility 100 to be shared between plural of the delivery vehicles 12.

Although in the exemplary embodiment described above the first area is the floor surface 110 inside the facility 100, i.e. indoors, and the second area is the road surface 24A of the road 24 outside the facility 100, i.e. outdoors, the present disclosure is not limited thereto. As long as the second area is more dirty than the first area then, for example, the first area and the second area may both be indoors, such as for example an area in a factory where there is oil, water, or the like present on the travel path in the second area, and the first area is an area other than the first area. Moreover the second area may be a toilet area or the like, and the first area may be an area other than the toilet area. Moreover, in cases in which both the first area and the second area are outdoors, the second area may be a bad road where muddy water or the like is present, and the first area may be an area other than the bad road.

Moreover, although the exemplary embodiment described above is configured such that at the start of travel the storage 36D of the delivery vehicle 12 receives the delivery route inside the facility 100 stored in the storage 80D of the large delivery vehicle 14, the present disclosure is not limited thereto. The delivery route may be received in advance from the storage 16D of the server 16 over the network.

Moreover, although in the exemplary embodiment described above the large delivery vehicle 14 is able to stow plural of the delivery vehicles 12, the present disclosure is not limited thereto. The large delivery vehicle 14 may be configured so as to be able to stow a single delivery vehicle 12.

Moreover, although in the exemplary embodiment described above the movements of the delivery vehicle 12 are managed by the control section 36, and the movements of the large delivery vehicle 14 are managed by the control section 80, there is no limitation thereto. Namely, the movements of both the delivery vehicle 12 and the large delivery vehicle 14 may be managed by the server 16 depending on the number of the delivery vehicles 12 and the number of the large delivery vehicles 14 contained in the transport system 10.

Moreover, although in the exemplary embodiment described above each processing is executed by the CPU 36A illustrated in FIG. 3, the CPU 80A illustrated in FIG. 6, or the CPU 16A illustrated in FIG. 8 reading software (or programs), execution may be made with various processors other than CPUs. Such processors include programmable logic devices (PLD) that allow circuit configuration to be modified post-manufacture, such as a field-programmable gate array (FPGA), and dedicated electric circuits, these being processors including a circuit configuration custom-designed to execute specific processing, such as an application specific integrated circuit (ASIC). Each of the above described processing instances may be executed by any one of these various types of processors, or may be executed by a combination of two or more of the same type or different types of processors (such as plural FPGAs, or a combination of a CPU and an FPGA). The hardware structure of these various types of processors is more specifically an electric circuit combining circuit elements such as semiconductor elements.

Moreover, each of the programs described in the present exemplary embodiment may be provided in a format recorded on a recording medium such as a compact disc read only memory (CD-ROM), digital versatile disc read only memory (DVD-ROM), universal serial bus (USB) memory, or the like. The programs may also be provided in a format downloadable from an external device over a network.

Although this ends the explanation of an exemplary embodiment of the present disclosure, the present disclosure is not limited thereto, and obviously various modifications other than these may be made within a scope not departing from the spirit of the present disclosure.

What is claimed is:

1. A transport system comprising:
a first moving body that is configured to transport a transport object by autonomous ground travel;
a second moving body that is configured to transport the first moving body by autonomous travel;
a memory; and
a processor coupled to the memory and that is configured to:
set delivery routes for each of the first moving body and the second moving body;
stow the first moving body travelling in the first area in the second moving body at a boundary where the set delivery route switches from a first area to a second area more dirty than the first area; and
cause the second moving body stowing the first moving body to travel in the second area.

2. The transport system of claim 1, wherein the first area is indoors and the second area is outdoors.

3. The transport system of claim 1, wherein the second moving body is configured to transport a plurality of the first moving body.

4. The transport system of claim 1, wherein the second moving body comprises a battery for supplying power to the first moving body.

5. The transport system of claim 1, wherein the second moving body comprises a battery chargeable from an external power source.

6. The transport system of claim 1, wherein the processor is further configured to set a delivery route in the first area for the first moving body, and set a delivery route in the second area for the second moving body.

7. The transport system of claim 1, wherein:
the first moving body comprises a first storage section for storing a delivery route in the first area; and
the second moving body comprises a second storage section for storing a delivery route in the second area.

8. The transport system of claim 7, wherein:
the second storage section is configured to store the delivery route in the first area and the delivery route in the second area; and
the first storage section is configured to receive the delivery route in the first area stored in the second storage section at a start of travel of the first moving body.

9. The transport system of claim 1, wherein:
the first moving body receives map information about a facility containing the first area from the facility, and returns or erases the map information when the first moving body exits from the facility.

10. The transport system of claim 9, wherein the map information is shared in cloud.

11. A transport control method comprising:
setting delivery routes for each of a first moving body that is configured to transport a transport object by autonomous ground travel and a second moving body that is configured to transport the first moving body by autonomous travel;
stowing the first moving body autonomously travelling in the first area in the second moving body at a boundary where the set delivery route switches from a first area to a second area more dirty than the first area; and
causing the second moving body stowing the first moving body to travel autonomously in the second area.

12. The transport control method of claim 11, further comprising:
in a case in which the second moving body stowing the first moving body is determined to have arrived at the boundary, causing the first moving body to depart from the second moving body and to travel autonomously in the first area.

13. The transport control method of claim 12, further comprising:
the first moving body receiving and storing map information related to the first area prior to departing from the second moving body.

14. The transport control method of claim 11, further comprising stowing the first moving body in the second moving body in a case in which the first moving body travelling autonomously in the first area has been determined to have arrived at the boundary.

15. The transport control method of claim 14, wherein map information stored in the first moving body related to the first area is erased prior to stowing the first moving body in the second moving body.

16. A non-transitory storage medium storing a program executable by a computer to perform transport control processing, the transport control processing comprising:
setting delivery routes for each of a first moving body that is configured to transport a transport object by autonomous ground travel and a second moving body that is configured to transport the first moving body by autonomous travel;
stowing the first moving body autonomously travelling in the first area in the second moving body at a boundary where the set delivery route switches from a first area to a second area more dirty than the first area; and
causing the second moving body stowing the first moving body to travel autonomously in the second area.
